(19) United States
(12) Patent Application Publication
(10) Pub. No.: US 2010/0155200 A1
(43) Pub. Date: Jun. 24, 2010

(54) PUSH BODY AND CONVEYOR UNIT

(75) Inventor: Walter Reist, Hinwil (CH)

Correspondence Address: RANKIN, HILL & CLARK LLP, 38210 Glenn Avenue, WILLOUGHBY, OH, 44094-7808, US

(73) Assignee: WRH WALTER REIST HOLDING AG, Ermatingen (CH)

(21) Appl. No.: 12/643,455

(22) Filed: Dec. 21, 2009

(30) Foreign Application Priority Data
Dec. 23, 2008 (CH) 2010/08

(51) Int. Cl. B65G 17/38

(52) U.S. Cl. 198/850

(57) ABSTRACT

A push body for transmitting push forces in a conveyor device includes a link having, at a first end, a first joint element formed by a joint body and, at a second end, a second joint element formed by a joint socket. The joint elements are shaped corresponding to one another. At least one of the joint elements is provided with a protective element.

### BACKGROUND OF THE INVENTION

1. Field of the Invention

The invention lies in the field of devices for force transmission or for the conveying and transport of objects, and relates to a push body and to a conveyor unit according to the preamble of the respective independent patent claims.

2. Description of Related Art

Such a conveyor unit is known for example from CH 538 065 (U.S. Pat. No. 3,757,514). A link chain comprises links which are connected in the manner of a ball joint, with in each case a joint body and a joint socket. The joint socket is slotted and thus capable of being spread apart, so that a joint body may be inserted into the joint socket of the connecting link. A sleeve may be applied over the joint socket in order to prevent a spreading of this. The sleeve may also serve for a low-friction mounting of the chain link in a guide. The slotted joint sockets and their possibility of spreading result in a greater wear and fatigue of the material, which necessitates an increased maintenance and monitoring requirement.

A further ball joint link chain is described in DE 31 21 835 A1 (GB 2 077 881), whose individual chain links are divided along an axial plane into two halves, and after connection to the connecting chain link, are held together in each case by retaining rings.

CH 655 916 describes a device for manufacturing a connection between stations of an installation. The device comprises a link chain similar to that described in DE 31 21 835 A1, which however yet comprises through-openings along the longitudinal axis of the chain links. An electrical cable is led through these through-openings, which serves for the communication between two stations along the link chain. A fibre-optic or a hollow guide is also mentioned instead of an electrical cable. The joint chain at a first end may be conveyed out of a magazine. The cable at this first end of the link chain is firmly connected to a main station. A coupling member is arranged at the other end of the link chain or the cable, and may be connected in each case to intermediate stations which are arranged along a guide channel. For this, the link chain is conveyed into a position, with which the coupling member is located at the intermediate station. Thus, the cable may be connected to the intermediate station. However, several coupling members may also be present, which are arranged at a distance along the link chain. The manufacture of such a link chain is expensive.

WO 98/13281 A1 discloses a force transmission means for transmitting push forces. It consists of a sequence of transmission elements which abut one another on their end-faces and comprise an annular tongue and an annular groove which may be pivoted against one another. The transmission elements may have an axial lead-through, through which a connection means is led, for the loose connection of the transmission elements, in particular an electrical cable.

U.S. Pat. No. 1,939,766 shows a force transmission device with push bodies which are strung on a central cable, just as EP 1 059 462 A1.

Drives for the joint chains are disclosed in DE 2 203 495 (by way of a wrapping belt) and EP 0 077 467 A2 (by way of a gearwheel).

A drive device for moving the end plate of a safety belt is described in DE 31 36 335. Push members which are strung on a cable and optionally provided with teeth, are moved by a drive. The end plate is fastened via a spring system on the last of the push bodies and is fastened at the end of the cable.

### BRIEF SUMMARY OF THE INVENTION

It is the object of the invention, to provide a chain link or a push body and a conveyor unit, which are simple to manufacture and may be applied in a comprehensive manner.

This object is achieved by a push body and a conveyor unit according to the respective independent patent claims.

A push body for transmitting pressing forces in a conveyor device thus comprises a link, which at a first end comprises a first joint element formed by a joint body, and at the second end, a second joint element formed by a joint socket, wherein the joint elements are shaped corresponding to one another. Thereby, at least one of the joint elements is provided with a protective element.

The protective element protects the joint elements, thus the joint sockets and joint bodies, from wear and knocks, and reduces the friction at the joints. This is effected in particular by way of the selection of the material pairing between the protective element and the joint element which is moveably in contact with the protective element. The material of this protective element is thus matched to a base material of the link, in order to optimally utilise the tribological characteristics of the material pairing, for example with regard to the wear and self-lubrication, in order to achieve a friction number of, for example, f≦0.2.

In a preferred embodiment of the invention, the links are manufactured of plastic, and the protective members of metal, for example brass or steel, in particular of precipitation-hardened steel, whose surface has a roughness Rₛ of 0.05 to 0.2 to 0.7 micrometers. Preferably, the protective elements are manufactured by way of deep-drawing. The surface of the protective element may be compacted by way of specific methods or also may be coated with a flame spray coating layer.

The push bodies preferably comprise single-piece links, on which the joint sockets and joint bodies are formed. The protective elements may be formed by way of treatment of the surface of the push bodies, for example by way of compacting the surface or by way of coating with a metallic substance, such as chrome.

The protective elements may, however, in each case be bodies which are separate from the links of the push bodies and which are stuck onto the push bodies at the joint bodies, or applied into the joint sockets. The protective elements are preferably connected to the respective joint element with a non-positive fit or positive fit or material fit via a sliding fit or slide fit or interference fit (also called a tight fit).

Preferably, the individual portions of the push body in each case have a rotationally symmetrical shape. By way of this, it is possible to provide a through-opening in the inside of the push body in the same manufacturing step. Moreover, one may refine sharp-edged or pointed transitions during the manufacture of the push body. This protects an optional cable or wire which is applied in a preferably centric manner and in the axial direction in the through-openings.

The protective element preferably likewise has a simple rotationally symmetrical shape. With this, a particularly simple large scale manufacture of all components may be achieved, for example by way of injection moulding the links and deep-drawing the protective elements. The protective element, should the link have a through-opening, likewise comprises an opening arranged in the extension of the through-opening of the respective link.

In a preferred embodiment of the invention, a spring element is present, which may accommodate forces between adjacent push bodies, above all in the axial direction and thereby absorb or damp these. The spring element, thus, acts between two push bodies and presses these apart. The spring element may bear on the push bodies in a loose manner or it may be clamped in at least one of the adjacent push bodies or fastened in another manner. In the case that a connection means such as a cable or wire is present, which holds the push bodies together, the push bodies and the connection means, acting as a pull means, may be tightened to one another. Also, in the case that no connection means is present, one or more spring elements may still act between the push bodies for damping and absorbing. Shocks are absorbed by way of this and the life duration of the push bodies is increased.

Preferably, a recess or a stuck-on abutment sleeve on an outer portion of the push body forms a seat or an outer seat for a first end of a spring element, for holding the spring element. A preferably cylindrical inner seat in the region of the joint socket in the push body forms a mounting of a second end of the spring element. The spring element encloses, preferably, a section of a push body, which lies between the two joint elements, for example in an essentially rotationally symmetrical arrangement.

Push bodies which are chained to one another and in particular held together by way of a connection means, form a conveyor unit. The connection means designed for receiving tensile forces or the pull means is led through the through-openings of the push body and is fastened on a first member and on a last member of the conveyor unit, for accommodating tensile forces.

At least one spring element tightens the push body against the connection element. By way of this, when the conveyor unit is driven by a drive, which with a toothing engages on the push bodies, the engagement of the toothing is improved, i.e. the engagement is synchronised better than with push bodies which follow one another partly in a loose manner. By way of this, in turn, the vibrations and the running noises such as rattling are reduced. The preferred rotationally symmetrical shape of the distance bodies is well suitable for a drive of the conveyor unit.

Preferably, the through-opening is widened in the region of the first and/or the second joint elements. This widening or expansion may be realised, for example, by way of a conical surface. Thereby, the transition from such a lead-through cone to the through-opening is preferably rounded. A buckling of the connection means with links which are angled to one another is reduced by way of this widening and rounding.

In a preferred embodiment of a conveyor unit, at least one push body comprises a catch or a catch member for conveying or driving further objects, or the catch is fastened on the push body. For this, a gripper or carrier may be attached, driven on the catch member or by the catch member. The wire or the cable may for example be used for an electrical supply or for communication signals.

The conveyor unit with the spring element may also be designed without the protective element.

Further preferred embodiments are to be deduced from the dependent patent claims.

### BRIEF DESCRIPTION OF THE DRAWINGS

The subject-matter of the invention is explained in more detail by way of preferred embodiment examples, which are represented in the attached drawings. In each case, in a schematic manner, there are shown in:

FIG. 1 a longitudinal section of a push body of a conveyor unit;

FIG. 2 a protective plate for the push body; and

FIG. 3 a conveyor unit.

The reference numerals used in the drawings and their significance are listed in a conclusive manner in the list of reference numerals. Basically, the same parts are provided with the same reference numerals in the figures.

### WAYS OF CARRYING OUT THE INVENTION

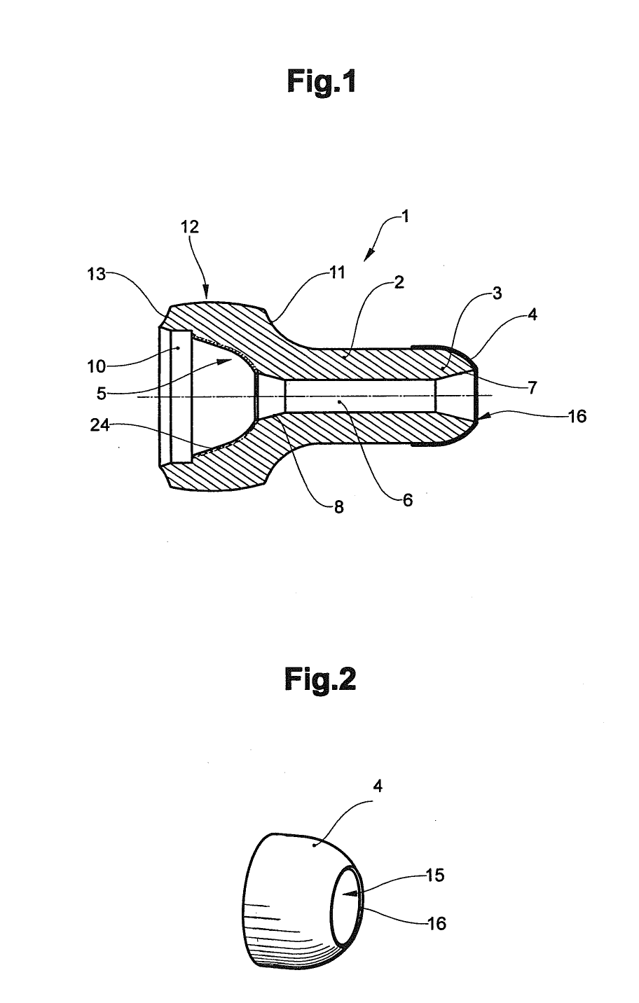

FIG. 1 shows a rotationally symmetrical push body 1, comprising a peg-like link 2 with a convex joint body 3 and with a concave joint socket 5. The joint body 3 is provided with a protective element 4. Additionally or alternatively, the joint socket 5 may be provided with an inner protective element 24 (drawn in a dashed manner). Thereby, the joint body 3 which is cambered to the outside, with a positive fit, fits into the joint socket 5 of an adjacent push body 1, said joint socket being cambered to the inside.

The thickening in the thicker region has a rotationally symmetrical, preferably cambered surface, hereinafter called tooth surface 12. At a front shoulder region 11, the tooth surface 12 merges into the thinner part of the link 2, which leads to the joint body 3, and at a rear shoulder region 13, merges into the joint socket 5. The two shoulder regions 11, 13 preferably comprise a mirror-image profile and together with the tooth surface 12 form an engagement body, on which a gearwheel or another conveyor device for driving the conveyor unit 17 may engage.

A through-opening 6 running in the axial direction, preferably on both sides, i.e. at the joint body 3 and at the joint socket 5, comprises a cone-shaped, respectively front and rear widening 7, 8. This leads a cable or a pull wire, so that the cable is not kinked or damaged with deflection movements of the joints.

The joint socket 5 preferably comprises an inner seat 10 for a spring element 9. The joint socket 5 is formed in the region of a thickening of the link 2, on which a drive may engage. An abutment sleeve 22 for supporting a spring element 9 is stuck on a shoulder 11 lying opposite the joint socket 5, on the outer side of this thickening. Alternatively a seat or an outer seat may be recessed on the thickening as one piece, for supporting a spring element 9. The outer seat or the abutment sleeve 22 forms a support surface lying essentially perpendicular to the longitudinal axis of the push body.

Dimensions for a push body are, for example, a length of 50 mm and a largest diameter of 33 mm. The size in other embodiments may also be half or double these.

FIG. 2 shows a protective element 4 in the form of a cambered protective plate with an optional opening 15 running in the axial direction, for a cable lead-through. The protective element 4 fits onto the outer side of the joint body 3 as well as preferably also onto the inner side of the joint socket 5, with a positive fit. An inner hole edge of the opening 15 comprises a rounded hole edge 16, which prevents damage to a connection means or pull means. After sticking-on or inserting, preferably a surface pressing exists between the protective element 4 and the corresponding joint element 3, 5.

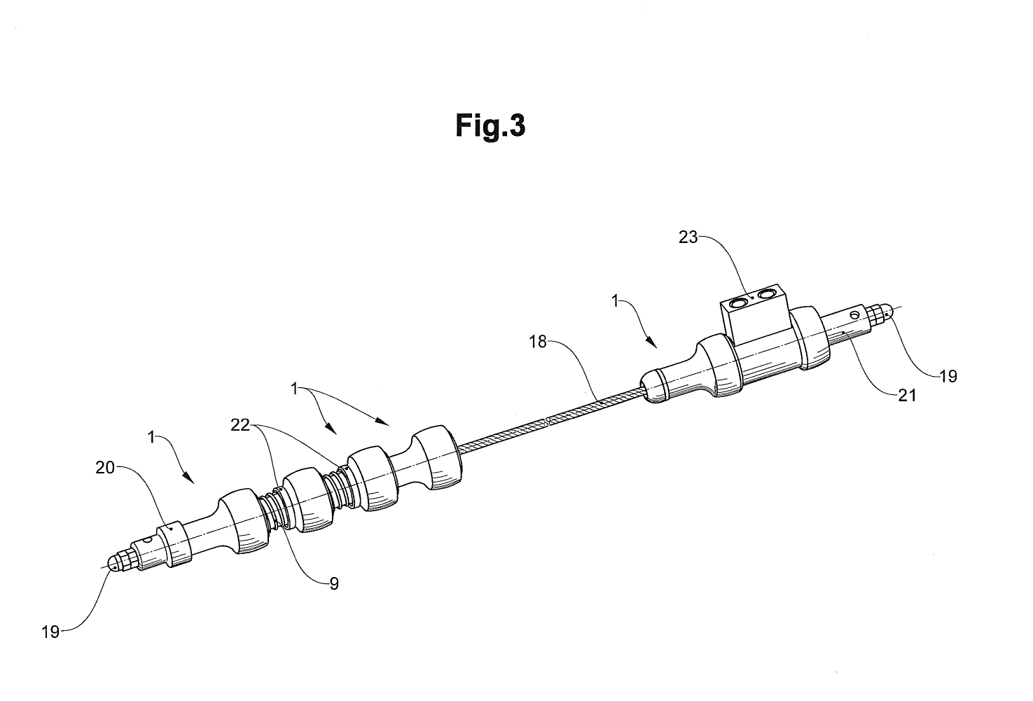

FIG. 3 shows a conveyor unit 17 with several push bodies 1 which are rowed on one another, i.e. strung together. A connection means 18, for example a wire cable or plastic cable, is led through the through-openings 6 of the links 2 and is fixed on a first link 20 and on a last link 21 of the conveyor unit 17, in each case by way of a fastening means 19. The connection means 18 is biased by spring elements 9, so that the push bodies 1 of the conveyor unit 17 are pressed against one another. By way of this, a stabilisation of the conveyor movement and an improved and constant engagement meshing for a drive is achieved. The spring elements 9, as drawn, are for example spiral springs, or sleeves of an elastic material such as rubber or a plastic. The spring elements 9 are inserted at one end in the inner seat 10 of a push body 1. At the other end, they lie on a seat or outer seat or an abutment sleeve 22, so that they are not widened by the front shoulder 11. The inner seat 10, together with an inserted spring element 9, effects a stiffening of the conveyor unit 17, by which means under certain circumstances, over short sections and depending on the push loading of the conveyor unit, one may make do without an outer guide of the conveyor unit.

Only one spring element 9 as a clamping means is drawn in FIG. 3, but also several spring elements 9 may be arranged along the conveyor unit 17, either one after the other or distributed over the length of the conveyor unit 17, or between all push bodies 1. For example, a catch may be arranged at the end of the conveyor unit 17, on which parts may be fastened.

A biasing may, however, alternatively or additionally be produced by way of the connection means 18 being elastic, or by way of the pull means 18 being connected, with an elastic fastening, to the first or last link 20, 21. Slight length changes of the pull means 18 which could arise with a curvature of the conveyor unit 17, are compensated by this elasticity.

### LIST OF REFERENCE NUMERALS

1 push body
2 link
3 joint body
4 protective element
5 joint socket
6 through-opening
7 conical widening (front)
8 conical widening (rear)
9 clamping element, spring
10 receiver for spring, inner seat
11 front shoulder
12 tooth diameter
13 rear shoulder
15 through-opening of protective element
16 inner hole edge
17 conveyor unit
18 connection means, cable
19 fastening means
20 first link
21 last link
22 abutment sleeve
23 catch
24 inner protective element

1. A push body for transmitting push forces in a conveyor device, wherein the push body comprises a link, which at a first end comprises a first joint element formed by a joint body, and at a second end comprises a second joint element formed by a joint socket, wherein the joint elements are shaped corresponding to one another, and wherein at least one of the joint elements is provided with a protective element to protect the joint elements and for to reduce friction between the joint elements of successive push bodies.

2. The push body according to claim 1, wherein a base material of the link is plastic.

3. The push body according to claim 1, wherein a base material of the link is a metallic material.

4. The push body according to claim 1, wherein the push body (1) has a rotationally symmetrical shape.

5. The push body according to claim 1, wherein the surface of the protective element is compacted.

6. The push body according to claim 1, wherein the surface of the protective element has a roughness of between about 0.05 micrometers to 0.7 micrometers.

7. The push body according to claim 1, wherein the link is of one piece and the joint elements are integrally formed on the link.

8. The push body according to claim 1, wherein the protective element is formed by a coating of the respective joint element.

9. The push body according to claim 1, wherein the protective element is a metallic body separate from the link.

10. The push body according to claim 9, wherein the protective element is connected to the respective joint element by way of one of a positive fit, material fit or non-positive fit selected from the group consisting of a sliding fit, slide fit and an interference fit.

11. The push body according to claim 9, wherein the link comprises an axial through-opening, and the protective element comprises an opening that is arranged in the extension of the through-opening.

12. The push body according to claim 11, wherein an inner hole edge of the opening of the protective element has a rounding or chamfer.

13. The push body according to claim 9, wherein a seat for a spring element is arranged on the outer side and/or on the inner side of the push body.

14. A push body according to claim 13, wherein an inner seat for receiving the spring element is recessed in the region of the joint socket.

15. The push body according to claim 13, wherein the joint socket is formed in the region of a thickening of the link, and, on a shoulder lying opposite the joint socket, at the outer side of this thickening, a seat for supporting a spring element is recessed or an abutment sleeve for supporting a spring element is stuck on.

16. A conveyor unit comprising a plurality of push bodies according to claim 1, wherein the push bodies comprise an axial through-opening, and a connector designed for accommodating tensile forces, said connector being led through the through-openings of the push bodies and being fastened on a first link and on a last link of the conveyor unit for accommodating tensile forces, and the push bodies are tightened against the connector by at least one spring element.

17. The conveyor unit according to claim 16, wherein the at least one spring element acts between two push bodies and presses the two push bodies apart.

18. The conveyor unit according to claim 16, wherein the spring element encloses a section lying between the two joint elements of a push body.

19. The conveyor unit according to claim 16, wherein the spring element is one of a sleeve of an elastic material or a spiral spring.

20. The conveyor unit according to claim 16, further comprising at least one catch for conveying or driving further objects, wherein the at least one catch is fastened or integrally formed on one of the push bodies.
